(19) United States
(12) Patent Application Publication
(10) Pub. No.: US 2023/0019776 A1
(43) Pub. Date: Jan. 19, 2023

(54) ION EXCHANGE SYSTEM AND METHOD FOR CONVERSION OF AQUEOUS LITHIUM SOLUTION

(71) Applicant: BL TECHNOLOGIES, INC., Minnetonka, MN (US)

(72) Inventor: DAVID BISHKIN, Bellevue, WA (US)

(21) Appl. No.: 17/791,159

(22) PCT Filed: Jan. 14, 2021
(86) PCT No.: PCT/US2021/013430

§ 371 Date: Jul. 6, 2022

Related U.S. Application Data
(60) Provisional application No. 62/962,595, filed on Jan. 17, 2020.

(51) Int. Cl. C22B 3/42; B01J 39/05; B01J 47/10; B01J 47/026; B01J 49/10; C22B 3/02; C22B 26/12

(52) U.S. Cl. CPC C22B 3/42; B01J 39/05; B01J 47/10; B01J 47/026; B01J 49/10; C22B 3/02; C22B 26/12

(57) ABSTRACT

Systems and methods use ion exchange to extract lithium from a lithium-containing feed solution such as a salar brine. Lithium ions are loaded into an ion exchange resin and then eluted while recharging the resin. Sodium hydroxide or sodium bicarbonate may be used to recharge the resin but are not directly mixed with the lithium-containing feed solution. An eluate stream is produced containing lithium hydroxide or lithium bicarbonate. Lithium hydroxide can be precipitated as lithium hydroxide or in a hydrate form. Lithium bicarbonate may be converted to lithium carbonate. The system and method optionally includes processing an eluate stream to recover one or more compounds for re-use in regenerating the resin bed.

### CROSS-REFERENCE TO RELATED APPLICATIONS

This application claims the benefit of U.S. patent application Ser. No. 62/962,595, filed Jan. 17, 2020, which is incorporated by reference.

### FIELD

This specification relates to systems and methods for treating aqueous lithium solutions, for example lithium containing groundwater or brine, and to ion exchange.

### BACKGROUND

Demand for lithium around the world has increased due to its varied uses across a number of industries including for example, use in ceramics, batteries, chemical additives, and in nuclear applications. Lithium ion batteries are in particularly high demand and represent the greatest consumer of lithium. Some techniques have been investigated for extracting high purity lithium from crude sources such as lithium containing ores, clays, and brines in order to keep up with the increasing demand.

Conventionally, lithium is extracted from crude sources via evaporation and precipitation techniques. For example, brines extracted from underground reservoirs (salar brines) containing lithium are pumped into evaporation ponds and undergo solar evaporation over a number of months or years. Lithium chloride concentrated in the ponds after evaporation is sent to a recovery plant for pretreatment to remove contaminants (such as boron or magnesium) for example via a solvent extraction process and filtration. The remainder is then treated with a reagent such as sodium carbonate (soda ash) or sodium hydroxide in order to precipitate a saleable lithium product such as lithium carbonate or lithium hydroxide. The conversion rates of LiCl to Li₂CO₃ using these conventional methods may be around 78-88%. The resultant products may contain undesirable amounts of Cl⁻ or SO4⁼ contaminants.

Other methods of treating lithium-containing brines include using mechanical vapor recompression (MVR) evaporators and/or multi-effect steam powered distillation processes in place of evaporation ponds. In other options, the evaporation process is sped up by reverse osmosis used to concentrate the lithium brine.

### INTRODUCTION TO THE INVENTION

The following paragraphs are not intended to limit or define the invention. The invention relates to systems and/or methods for treating lithium-containing solutions, for example salar brines or other natural sources of water containing lithium. The systems and methods use ion exchange to avoid the direct addition of sodium carbonate, sodium hydroxide or a similar reagent to filtered solutions. Lithium ions are loaded into an ion exchange resin and then eluted while recharging the resin. Although sodium hydroxide or sodium bicarbonate may be used to recharge the resin, they are not directly mixed with the lithium-containing feed solutions. This may reduce the potential for contamination in the final product, including for example contamination by sodium chloride or sodium sulfate, in the final product. The system or method optionally includes processing an eluate stream to recover one or more compounds for re-use in regenerating the resin bed. In some cases, the conversion rate may also be increased, the energy consumption may be reduced and/or the production of waste products may be reduced, relative to a process with direct addition of the reagent. In some cases, a separate solvent extraction step to remove one or more contaminants, for example boron, is not required.

In some examples, a method is used for treating a softened aqueous feed solution containing monovalent cations, chiefly lithium (for example a feed solution wherein at least 50% of the cations are lithium on a molar basis) but optionally also other ions including chloride, borate and sulfate. The method includes passing the feed solution through an ion exchange resin, for example a strong acid ion exchange resin bed, loaded with monovalent cations other than lithium (optionally called a “counterion” herein), typically sodium. Lithium ions in the feed stream are exchanged with the counterions (i.e. sodium) in the resin creating a raffinate stream comprising the counterions (i.e. sodium) is withdrawn from the ion exchange resin bed. To recharge the ion exchange resin bed, an eluent stream comprising monovalent cations, including a desired counterion, is passed through the ion exchange resin bed to exchange the Li+ ions of the resin with monovalent cations other than lithium (i.e. sodium) of the eluent stream. The eluent stream may contain, for example, sodium carbonate and/or sodium bicarbonate, or sodium hydroxide. An eluate stream comprising lithium hydroxide or lithium carbonate and/or lithium bicarbonate is produced as the eluent stream passes through the ion exchange resin. Optionally, the method may be performed at elevated temperatures up to the maximum operating temperature of the resin (typically 300 F).

The eluate stream may be treated further. In some examples, water is removed from an eluate stream containing lithium hydroxide, for example by evaporation and/or electrodialysis, to produce a lithium hydroxide or lithium hydroxide hydrate crystal. Optionally, a residual liquid remaining after separating the precipitate may be used to at least partially regenerate the ion exchange resin bed. In some examples, an eluate containing sodium bicarbonate is heated to remove water and convert bicarbonate ions to carbonate ions. Lithium carbonate may be precipitated from the eluate. Carbon dioxide released from the eluate due to the decomposition of bicarbonate may be used to convert a sodium carbonate solution to a sodium bicarbonate solution for use in regenerating the anion exchange bed.

In some examples, a system for treating a lithium solution has an ion exchange resin bed. The system may also have a source of a sodium hydroxide, sodium carbonate or sodium bicarbonate solution. Optionally, the system may have one or more brine-concentrating units, for example an evaporator or electrodialysis device. Optionally, a source of sodium bicarbonate may include a source of sodium carbonate and a scrubber tower in communication with an evaporator.

### BRIEF DESCRIPTION OF THE FIGURES

FIG. 1 is a schematic drawing of a prior art process for extracting lithium from a solution.

FIG. 2 is a schematic drawing of an ion exchange process for extracting lithium from a solution and recharging a resin bed with a carbonate or bicarbonate solution.

FIG. 3 is a photograph of an ion exchange system having three resin beds in series.

FIG. 4a is a schematic drawing of recharging a resin bed with a sodium hydroxide solution to elute lithium hydroxide.

FIG. 4b is a schematic drawing of an ion exchange process for loading lithium from a feed solution into the resin bed of FIG. 4a.

FIG. 5 is a process flow diagram of an ion exchange process for extracting lithium from a solution and recharging a resin bed with a sodium bicarbonate solution including regenerating the sodium bicarbonate solution.

FIG. 6 is a schematic drawing of an ion exchange process for extracting lithium from a solution and recharging a resin bed with a sodium hydroxide solution.

FIG. 7 is a schematic process flow diagram of a process for treating an eluate containing lithium carbonate or lithium bicarbonate.

FIG. 8 is a schematic process flow diagram of a process for treating an eluate containing carbonates and bicarbonates of both lithium, and sodium, along with other monovalent cations.

FIG. 9 is a schematic process flow diagram of a process for treating an eluate containing hydroxides of both lithium, and sodium, along with other monovalent cations.

FIGS. 10A and 10B are graphs of experimental results for a process of extracting lithium from a solution and recharging a resin bed with a carbonate or bicarbonate solution.

### DETAILED DESCRIPTION

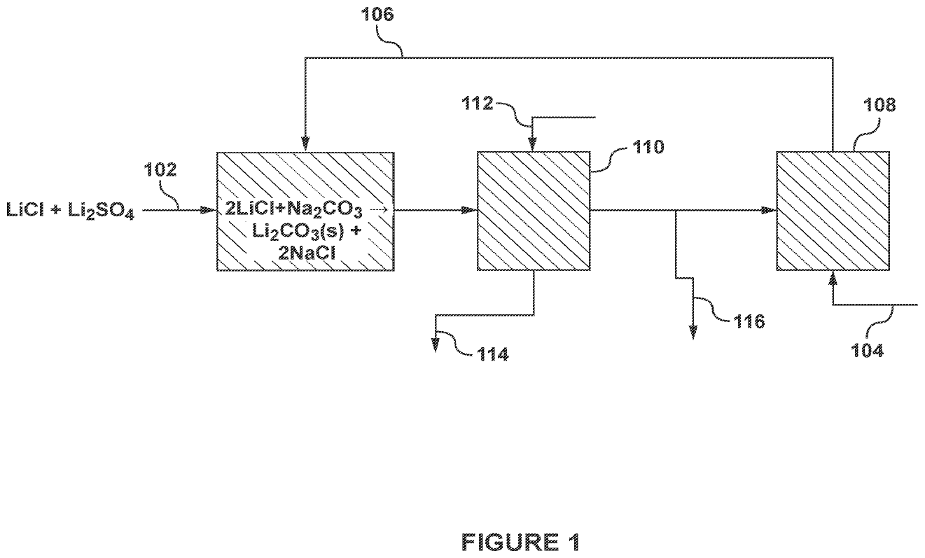

In a prior art process shown in FIG. 1, a crude (but pre-treated for example by solar evaporation and softening) lithium solution 102 is treated to produce a saleable lithium product such as Li₂CO₃ by way of the direct addition of sodium carbonate (soda ash) 104. A soda ash solution 106 from a soda ash dissolution step 108 is added to a solution containing LiCl and Li₂SO₄. The LiCl reacts with Na₂CO₃ according to the following reaction:

2LiCl(a)+Na₂CO₃(a)→Li₂CO₃(s)+2NaCl(a)

The products are passed through a solid-liquid separation step 110 and distilled water 112 is added to produce a washed Li₂CO₃ product 114. In practice, the conventional system results in Na⁺ and SO4⁼ contaminating the Li₂CO₃ lattice. This limits purity of the product. To remedy this, the conventional system includes a bleeding precipitation circuit 116, which bleeds Na and SO4⁼ to control product purity. However, this limits Li⁺ conversion and yield.

A system and process for treating lithium solutions described herein may be used in place of the direct addition of sodium carbonate as described above. The lithium solution is preferably pre-treated, for example by way of solar evaporation to concentrate the solution and softening to remove magnesium and calcium. Preferably, 50% or more or 60% or more or 70% or more of the cations, by mol, in the pre-treated solution are lithium. The system and process use one or more ion exchange resin beds to capture lithium ions from the feed solution. When the resin bed is recharged, an eluate stream is produced with different lithium salts in solution. Although it is not a conventional use of the term, the system may be called a metathesis system since it results, in a sense, in (a) the feed solution and (b) a resin bed recharging solution (eluent) exchanging ions and, with further processing of the eluate, in precipitation of a lithium product. Similarly, a process described herein may be called a metathesis process.

The metathesis system has a loading configuration and an elution configuration. The loading configuration has a feed stream comprising monovalent cations, preferably lithium ions, an ion exchange resin having a counterion form, preferably having a sodium ion form (Na+ form), and a raffinate stream. The elution configuration comprises an eluent stream, the same ion exchange resin used in the loading configuration but in a form representing the original cations of the feed stream, and an eluate stream.

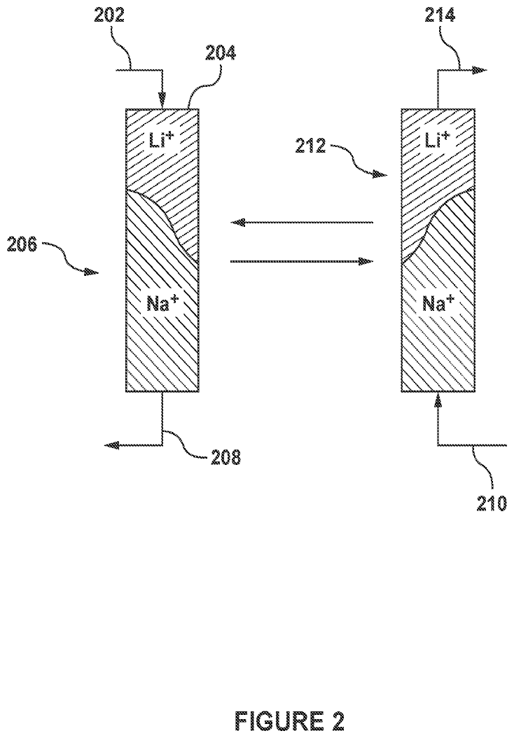

In one embodiment, as shown in FIG. 2, the feed stream in the loading configuration of the system comprises a softened lithium stream with boron 202. In other embodiments the feed stream may be a lithium cation bearing aqueous stream with silica, boron, chloride, sulfate, and/or other monovalent cations. The feed stream may have for example aqueous LiCl, aqueous Li₂SO₄ or aqueous LiB(OH)₄. The feed stream may be reduced in divalent cations, optionally substantially free of divalent cations. The ion exchange resin 204 in the loading configuration 206 of the system may be a strong acid cation exchange resin of typical household softener grade in Na+ form. In some embodiments the resin is of gel type, in bead form and arranged in a column configuration, but may be arranged in any other suitable configuration. The raffinate stream 208 is removed from the resin bed and comprises the sodium form of the anions in the feed stream. Typically, these anions include chloride or sulfate but the raffinate stream may also contain non-ionic species, such as for example, boron (B(OH)₃). The raffinate stream may comprise for example aqueous NaCl, aqueous Na₂SO₄, or aqueous NaB(OH)₄. In some examples, a conventional separate solvent extraction step to remove tramp solvents, such as NaB(OH)₄, prior to conversion to Li₂CO₃ is not used.

The eluent stream in the elution configuration 212 of the system is an aqueous solution comprising sodium ions, for example sodium hydroxide (NaOH), sodium bicarbonate (NaHCO₃), sodium carbonate, or NaHCO₃ mixed with sodium carbonate (Na₂CO₃). In other examples, the eluent stream may be an aqueous solution comprising potassium ions. Optionally, the aqueous solution is a strong base. The eluent stream may provide for indirect addition of soda ash using the ion exchange resin. The eluent stream is used to regenerate the ion exchange resin back to the sodium form (or K⁺ form) and elutes an eluate stream 214. The eluate stream contains Li⁺ ions combined with the anions of the eluent stream, for example carbonate anions, bicarbonate anions or hydroxide anions. The eluate may be essentially free of chloride or sulfate.

In an exemplary method of lithium metathesis, a feed stream comprising lithium ions is passed through a resin bed in a loading configuration, and the Li⁺ ions of the feed stream are exchanged for the counterions loaded on the resin bed. The counterions may be Na⁺ or K⁺ ions, or alternatively other suitable monovalent cations, possibly H⁺. A raffinate stream is eluted from the resin bed leaving behind an ion exchange resin in Li⁺ form. Optionally, the resin bed is rinsed with a low conductivity rinse, for example distilled water, to finish production of the raffinate stream. Then an eluent is passed through the resin bed in Li⁺ form and an eluate stream is extracted. Optionally, the resin bed is again rinsed with distilled water or other low conductivity rinse, to complete the production of the eluate. The eluate may then be crystallized. The resin bed is preferably in the form of a column or a series of columns. The eluent is preferably added column-wise, i.e. through a series of columns in a specified order. Optionally all fluids are added column-wise.

In another embodiment, a lithium cation bearing aqueous stream with other monovalent cations is passed through a strong acid cation resin bed loaded with Na⁺ ions. The Li⁺ ions and other monovalent cations of the solution replace the Na⁺ ions in the resin bed and the Na⁺ ions are removed from the resin bed with the anions (for example chloride or sulfate) in a raffinate stream. The raffinate stream also comprises any other non-ionic species that may have been introduced by the feed stream, such as boron. This results in a resin bed loaded with Li⁺ ions. The Li⁺ form of the resin bed is eluted with a sodium bicarbonate or sodium carbonate solution, optionally a mixed sodium bicarbonate and sodium carbonate solution. The Na⁺ ions replace the Li⁺ ions in the resin bed and Li⁺ ions, and optionally other monovalent cations, are extracted from the resin bed as lithium carbonate or bicarbonate or monovalent cation carbonate or bicarbonate.

In other examples, the Li⁺ form of the resin bed is eluted with a sodium or potassium hydroxide solution. The Na⁺/K⁺ ions replace the Li⁺ ions in the resin bed. The monovalent cations, including the Li⁺ ions, are extracted from the resin bed as lithium hydroxide or monovalent cation hydroxide. In another example, the Li⁺ form of the resin bed may be eluted with a hydrogen hydroxide (water reacting as a base) solution.

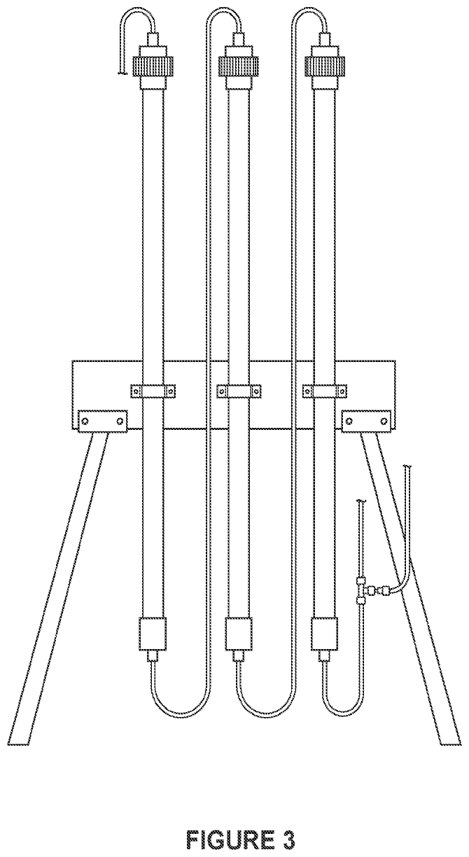

The resin bed used in the invention may be obtained, for example, from any suitable water softener supply reseller or other resin supply manufacturers. The resin is preferably a strong acid cation exchange resin, gel, or macroporous charged with sodium ions for softening applications. In other embodiments, the resin may be charged with K⁺ions. Optionally, weak acid or chelating resin may be used but the reaction is likely to be slower and require more resin. In another option, an anion exchange resin in the carbonate, bicarbonate or hydroxide form may be used, in which case the Li does not become part of the resin (the Li is optionally collected from the raffinate rather than the eluate) and the eluent may still be a NaOH or NaHCO₃ and/or Na₂CO₃ solution. The resin may be comprised of microbeads, for example gel resin beads. In other examples, the resin may be a sheet-like mesh resin, and a process may be powered by simple diffusion (dialysis) and/or by an electric field as in electrodialysis (i.e. four compartment electrodialysis with streams for the reagent (eluent), raffinate, eluate and feed). The resin bead particle size distribution may be for example between 50 to 3000 microns, or between 50 to 500 microns or between 50 to 150 microns, in diameter. The resin is preferably installed in columns, for example in reinforced plastic pipes or vessels, optionally having a length at least 3 times or at least 5 times their diameter. The system may use one column or multiple columns arranged in series. FIG. 3 shows an experimental set up of the metathesis system with 3 resin columns in series. The columns may be completely filled, preferably without provision for resin bed expansion. The ion exchange capacity is optionally around 2.2 meq/l, however a lower or higher ion exchange capacity may also be used. Optionally, the method is performed at an elevated temperature, for example 50° C. or more or 60° C. or more, which may reduce the amount of resin required.

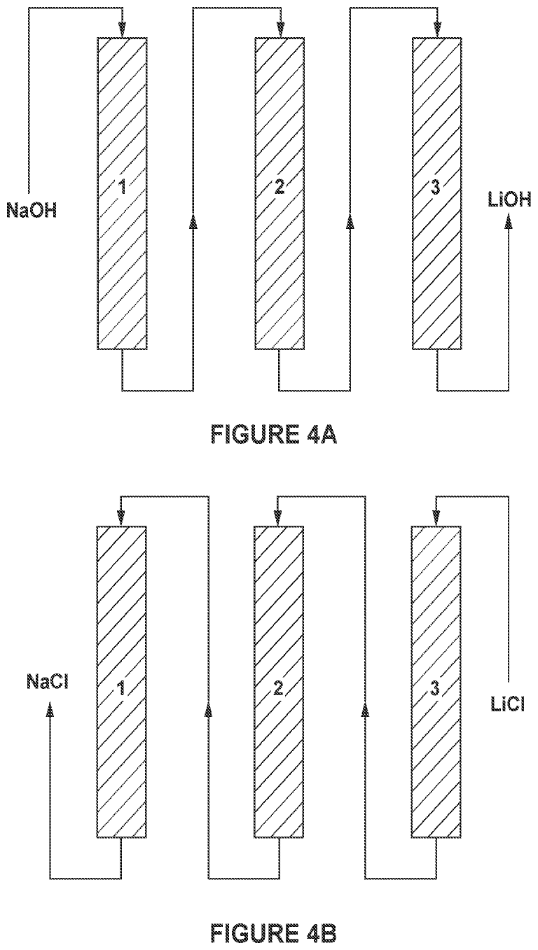

The columns of resin in series are preferably operated only in a down flow mode but in a reverse order of columns when the system is operating in an elution configuration compared to a feed configuration. A reversed down flow mode in a three column configuration for eluting Li off resin with NaOH, for example as shown in FIG. 4a, comprises the continuous addition of NaOH to a first column then a second column then a third column. The NaOH solution is followed by a low conductivity rinse to fully displace the LiOH eluate. When LiCl is added to the system in a loading configuration, the solution is passed through the resin columns in the opposite order of columns, as shown in FIG. 4b. LiCl is continuously added to the third column, followed by the second column, followed by the first column, allowing for improved efficiency of the system. A rinse may also be applied in this same reverse column-wise direction to fully displace the NaCl raffinate. Optionally, the direction of flow may be completely reversed, i.e. with up flow occurring in either the feed or eluent flow, with appropriate steps taken to avoid lifting resin up out of a column.

In another embodiment, a simulated moving bed system (SMB) comprising many (i.e. 10 or more) columns in series is used, for example as described in U.S. Pat. No. 2,985,589, which is incorporated herein by reference. The columns are connected in series and form a loop but a rotary valve (or multiple ordinary valves) changes the position of the feed to each column periodically, for example such that the last column receiving the feed process becomes the first column to receive the eluent. The SMB may be loaded with for example 50-300 micron resin beads. In an alternative example, a reciprocating flow ion exchange (RFIX) system (as in a reciprocating short bed ion exchange system but without necessarily using short beds) may be used, for example with 50-300 micron, i.e. 50-100 micron, resin beads may be used.

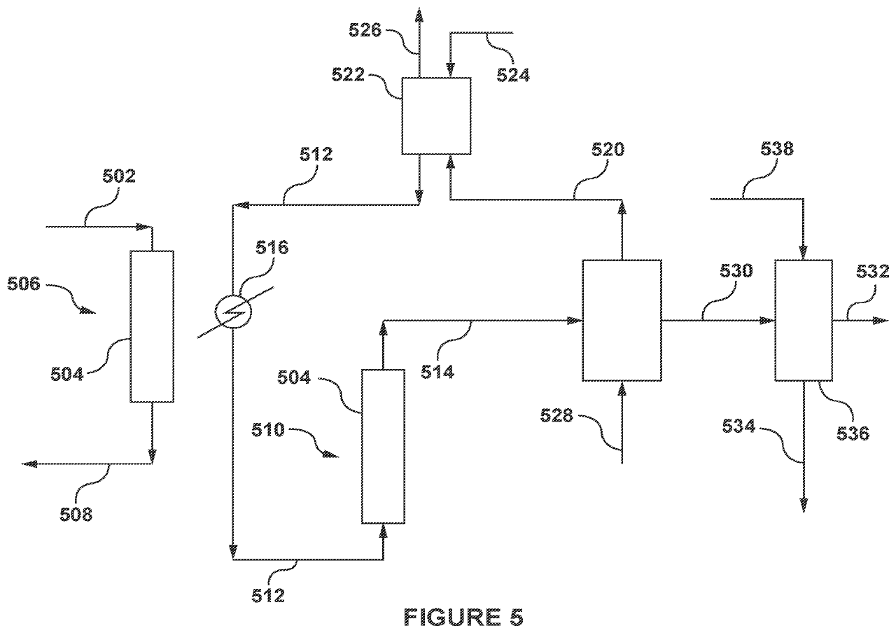

As shown in FIG. 5, an aqueous Li⁺ bearing stream with boron 502 that is free of divalent cations is passed through a strong acid cation resin bed 504 in a loading configuration 506 having a Na⁺ form. The Na⁺ is exchanged for the monovalent cations, including Li⁺, with the resulting stream 508 containing the sodium form of all of the anions, typically chloride or sulfate, and non-ionic species such as boron (i.e. B(OH)₃). In the elution configuration 510, the same strong acid cation resin 504 is in the form representing the original cations in the aqueous Li⁺ bearing stream. The resin is eluted with an aqueous sodium bicarbonate solution 512 to produce an aqueous eluate containing Li⁺ ions 514, among other cations, with bicarbonate anions. In some embodiments, the aqueous solution sodium bicarbonate is cooled 516 before being passed through the resin bed.

In some examples, the resin in the elution configuration is eluted with a solution comprising NaHCO₃ and Na₂CO₃ (soda ash) in order to avoid gas pockets forming in the resin bed, which may induce channeling. By mixing soda ash with the bicarbonate solution, the pH of the solution is raised to around 10 thereby reducing the likelihood of formation of CO₂ gas pockets.

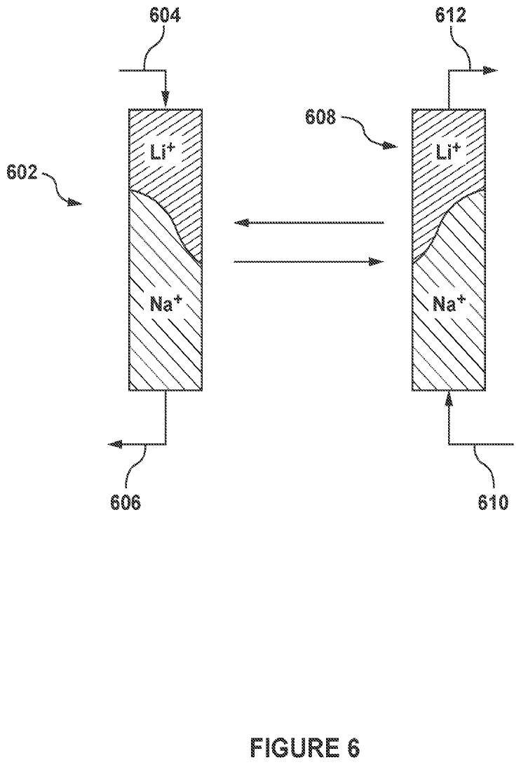

In another example, as shown in FIG. 6, a column of strong acid ion exchange resin in the Na⁺ form 602 is eluted with LiCl aqueous solution 604, for example with 2 w/w % LiCl aqueous solution. The LiCl solution displaces column wise the Na⁺ ions from the resin bed and replaces them with Li⁺ ions. A solution of NaCl is produced, for example a 6 w/w % solution of NaCl may be produced in a raffinate stream 606. The column may be rinsed with distilled water to fully elute the NaCl solution. The resulting resin column is in the Li⁺ form 608. The Li⁺ form resin column 608 is eluted with a solution of NaOH 610, for example with 4 w/w % solution of NaOH, displacing column wise the Li⁺ and replacing with Na⁺. An eluate solution 612 of LiOH is obtained, for example a 3 w/w % solution of LiOH may be obtained. The column may be rinsed with distilled water to complete elution of the LiOH solution. Each of the above steps may be repeated in each column in a series.

In some examples, the eluate aqueous solution achieved from the metathesis process is further converted into a solid lithium rich cake, for example by crystallization. The crystallization conversion reaction may be described by, for example:

2LiHCO₃(a)+H₂O(g)→Li₂CO₃(s)+CO₂(g)+H₂O(g+a)

In some examples, where aLiHCO3/Li2CO3 solution is produced, the eluate may further be crystallized using an evaporative crystallizer or other precipitation means using direct steam or via boiling by indirect heat. The resulting lithium carbonate slurry is filtered, washed and separated from the liquid fraction to produce a washed lithium carbonate cake for use. Carbon dioxide released during the crystallization step is recycled to a re-carbonation step where it is used to convert soda ash into sodium bicarbonate for reuse in the metathesis system.

Where LiOH eluate is achieved from the metathesis process, evaporation or electrodialysis techniques may be used to produce a LiOH*H₂O or LiOH crystalline product. Residual liquid after extraction of the crystalline product may be returned to the metathesis process (after partial or full recarbonation prior to use) as a preliminary eluent of the resin.

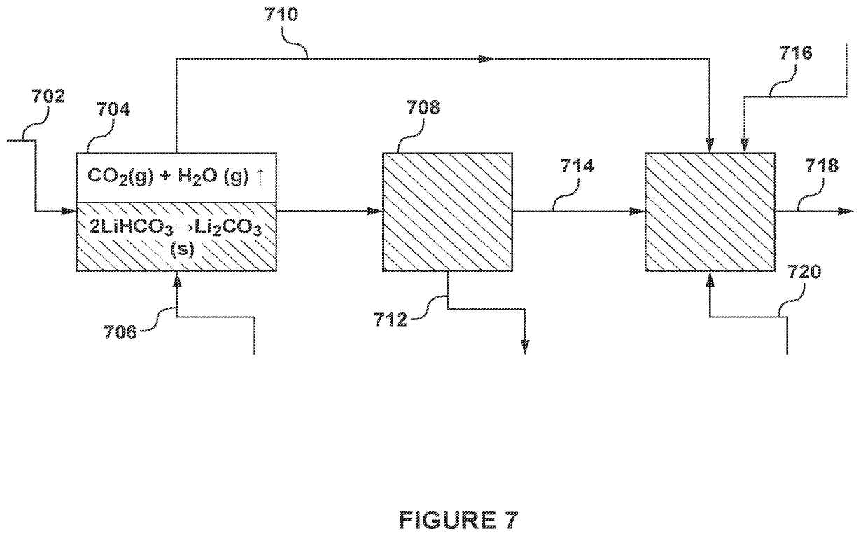

FIG. 7 shows an example conversion process for converting a Li bearing solution 702 containing LiHCO₃ (a) and Li₂CO₃ (a) from an SMB (or other ion exchange) system into Li₂CO₃ cake. In a precipitation stage 704, direct steam 706, or optionally boiling by indirect heat, is added to the Li bearing solution. Lithium bicarbonate reacts with steam to produce solid lithium carbonate, carbon dioxide and water. The lithium carbonate and water products of the reaction are passed through a solid-liquid separation stage 708. CO₂ gas 710 is sent to a re-carbonation stage. Lithium carbonate cake 712 is extracted from the solid liquid separation stage for use and the liquid fraction 714 is passed to the re-carbonation stage. Carbon dioxide from the precipitation stage is recycled for use in the re-carbonation stage. Soda ash (Na₂CO₃) 716 is added to the re-carbonation stage and converted to sodium bicarbonate 718 when reacted with a portion of the distillate and recycled CO₂. The re-carbonation stage is cooled 720 and sodium bicarbonate 718, along with any unreacted LiHCO₃, is extracted and may be returned to the metathesis process.

In another example, where recrystallization is desired, Li₂CO₃ is added to the re-carbonation stage in place of Na₂CO_{3.}

Returning to FIG. 5, a system for converting LiHCO₃(a) to Li₂CO₃(s) based on the process as described in FIG. 7 is shown connected to the lithium metathesis system. The eluate 514 released from the elution configuration of the resin bed which includes lithium (as well as other cations) with bicarbonate anions, is passed through an evaporative crystallizer 518. Heat 528 is added to the eluate in the evaporative crystallizer creating vapors of water and carbon dioxide. The decomposition of the bicarbonate ion creates carbon dioxide and carbonate ions, this is promoted by elevated temperatures and the stripping action of the evolving water vapor in the evaporative crystallizer. A vapor steam and carbon dioxide mixture 520 is released from the evaporative crystallizer to a carbon dioxide scrubber 522. The solution in the evaporative crystallizer becomes supersaturated in Li⁺ and CO3⁼ due to the loss of water and the increase in carbonate ions resulting in a slurry 530 which may be, using for example a solid liquid separator 536 and wash water 538, dewatered to a cake 532 and a resulting filtrate 534, for example a potassium and sodium purge brine, part of which may be returned upstream of metathesis to eliminate tramp anions such as chloride, the majority of filtrate being returned to the metathesis system to be used as an eluent. This prevents a buildup of K⁺ and Na⁺ (and other cations that may be present) in the evaporative crystallizer. A sodium bicarbonate stream 512 is created by scrubbing the vapors from the evaporative crystallizer with an aqueous solution of sodium carbonate 524, the sodium bicarbonate stream is then returned to the resin for another metathesis cycle. Steam 526 may be released from the carbon dioxide scrubber.

In another example where the eluate comprises an aqueous LiOH solution, the eluate may be subject to removal of water by evaporation or electrodialysis to the saturation point of LiOH. Further water is removed by evaporation to crystallize a LiOH*H₂O or LiOH crystalline product. The residual liquid phase after crystallization, which is concentrated in other monovalent cations of hydroxide, relative to Li⁺, is used as a preliminary regeneration of the lithium bearing cation resin before final regeneration with pure NaOH solution. This improves lithium recovery and reduces NaOH usage.

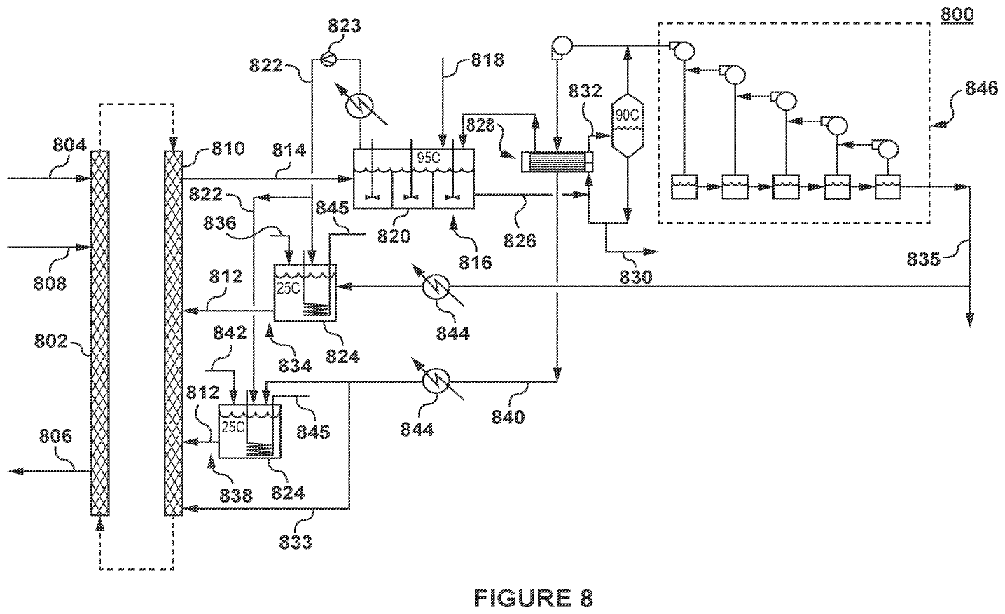

FIG. 8 shows an example of a system 800 and method of metathesis for converting LiSO₄ into solid Li₂CO₃ cake. A strong acid cation resin column in Na⁺ form 802 is eluted with LiSO₄ 804. The Li+ ions replace the Na+ ions in the resin column and Na₂SO₄ is extracted from the column in a raffinate stream 806. An optional rinse 808 of distilled water is used to complete elution of the Na₂SO₄ from the column. The resulting Li⁺ form resin column 810 is eluted with NaHCO₃ 812. The Li⁺ ions are replaced with the Na⁺ ions from the sodium bicarbonate and Li₂CO₃ 814 is released from the resin column. The Li₂CO₃ is released from the resin column at, for example, 25 degrees C. and 140 m³/h, and transported to a precipitation stage 816. In the precipitation stage, plant steam 818 is injected directly into a reactor 820, for example at around 95 degrees C. Alternatively where further energy conservation is desired, a reactor at a temperature as low as 70 degrees C. in a vacuum may be used. Carbon dioxide 822 is extracted from the precipitation stage and compressed, for example using a CO₂ compressor 823 at 3000 kg/h, and sent to one or more re-carbonation stages 824 while water and solid Li₂CO₃ 826 are transported to a solid-liquid separation stage 828. Li₂CO₃ cake 830 is extracted for use and may be substantially free of contamination from SO4⁼ ions. Water 832 is recovered from solid-liquid separation and recycled for use throughout the system, including as a rinse 833 for the resin column, or for use in a re-carbonation stage. In an optional primary elution circuit 834, recycled water from the solid-liquid separation unit containing for example high concentrations of Na₂CO₃ may be returned to a re-carbonation unit to form NaHCO₃ which can then be used as an eluent for the resin column in the Li⁺ form 810. A portion of the recycled water may also be released from the system in a bleed stream 835. The primary elution circuit may include an additional source of Na₂CO₃ to the re-carbonation unit. In a secondary elution step 838, which may occur after or in tandem with the primary elution step, or may be used without a primary elution step, recycled CO₂ 822 and distilled water 840 are introduced into the re-carbonation stage with a substantially pure source of the monovalent cation 842, for example Na₂CO₃, to produce NaHCO₃ which is then used as an eluent for the resin column in the Li⁺ form. Water for use in the primary and/or secondary elution steps may be cooled 844 before the recarbonation stage, and/or additional cooling water 845 may be used in the recarbonation stage. The process may be repeated until the desired levels of Li₂CO₃ are achieved. The process may also be repeated for each resin column in a series.

Optionally, the system as shown in FIG. 8 may also comprise a heat recovery stage 846 for distilling water to be reused in the process. The heat recovery stage may employ for example a multi-stage flash distillation system.

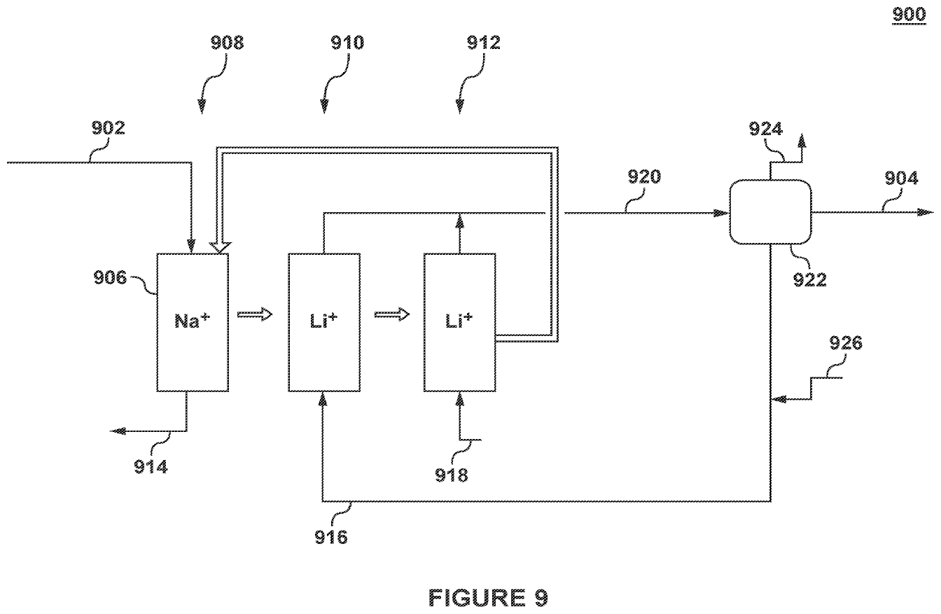

FIG. 9 shows an example of a system 900 and method of metathesis for converting a LiCl solution 902, optionally containing some NaCl and KCl, into solid/crystal LiOH*H₂O 904. The system includes a strong acid cation resin 906 that undergoes a loading step 908, an optional primary elution step 910 and a secondary elution step 912. In the loading step, the LiCl solution is loaded into the resin having Na⁺ form (which may also contain some K), while a NaCl solution (optionally with some KCl) is extracted from the resin column in a raffinate stream 914, transforming the resin column into Li⁺ form (which may also contain some Na and K). In an optional primary elution step, the resulting Li⁺ form resin column may be eluted with a recycled purge stream 916, also referred to as a mother liquor stream, from a crystallizer downstream of the resin column. The mother liquor may contain high concentrations of NaOH, KOH and some LiOH. The resin column may undergo a secondary elution step, either in addition to the primary elution step or on its own when a primary elution step is not used. In the secondary elution step the Li⁺ form resin is eluted with an essentailly pure source of a monovalent cation 918, for example hydroxide or bicarbonate, for example NaOH as used in the system of FIG. 9. An eluate 920 of LiOH may then be expelled from the resin column. The eluate may also include some NaOH and/or KOH. After expelling the eluate from the resin, the resin is returned to Na⁺ form. The eluate may be sent to an LiOH crystallizer 922. The crystallizer expels the crystallized LiOH*H₂O, a distillate stream 924 and a purge stream 916 which may be supplemented with dilution water 926. The purge stream may contain high concentrations of NaOH, KOH and some LiOH. The purge stream may be returned to the primary elution step, if there is a primary elution step.

### EXPERIMENTAL RESULTS

### Experimental Test 1

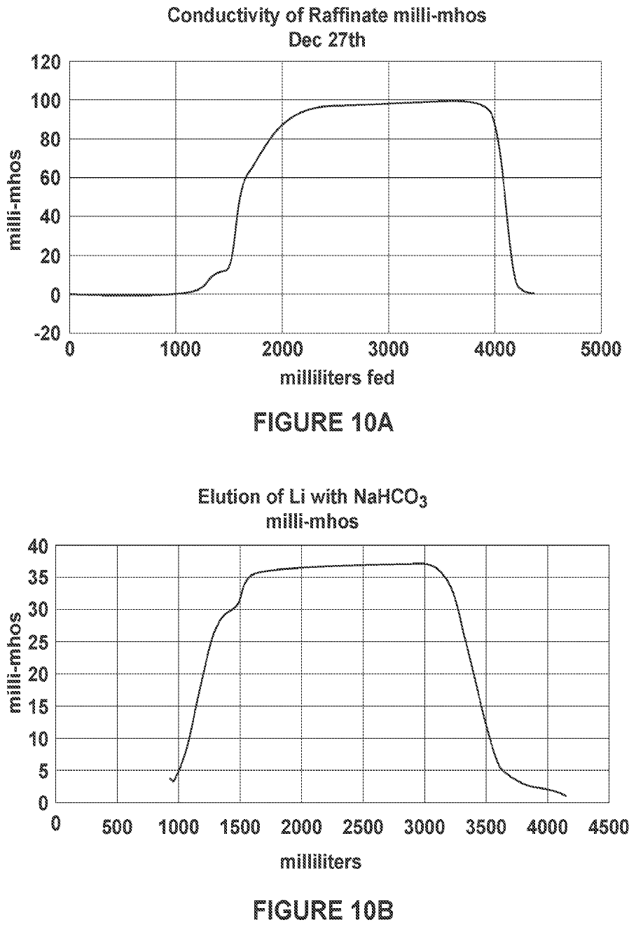

A lithium bearing feed solution was prepared with technical grade chemicals as shown in column 1 of Table 1 below. A series of 3 ion exchange columns are filled with strong acid cation resin (ordinary softener resin), each with a bed height of 975 mm and a diameter of 32.4 mm for a total resin volume of approximately 2400 ml. The bed was conditioned with 10 wt % solution technical grade sodium chloride at 25 ml/min followed by rinsing with distilled water to a conductivity of 7 uMohs. The series of resin bed were fed with 2000 ml of feed with the composition indicated in Table 1 below, at a rate of 27 ml/min. Conductivity was monitored and plotted in FIG. 10A. After loading the column, an eluting solution was prepared with distilled water, NaHCO₃, and Na₂CO₃. The solution comprised 21,000 mg/kg of Na, 46,000 mg/Kg of total alkalinity, and 13,500 mg/Kg of p-alkalinity. Approximately 2000 ml of the eluting solution was fed at a rate of 26 ml/min. The composition of eluate extracted from the column is shown in Table 2, below. The eluate conductivity profile is plotted in FIG. 10B. Results show that both SO4 and B were below detectable values in the eluate. The relative concentrations of Li, Na, and K in the eluate were the same as in the feed, although diluted.

TABLE 1
Feed and Raffinate Compositions

| LIMS | | | | | | | |
|---|---|---|---|---|---|---|---|
| 181211 | -01 | -02 | -03 | -04 | -05 | -06 | -07 |
| Raffinate | Feed | 1750 ml | 1900 ml | 2550 ml | 3050 ml | 3650 ml | 4200 ml |
| Date | 27-Dec | 27-Dec | 27-Dec | 27-Dec | 27-Dec | 27-Dec | 27-Dec |
| Na | 28,300 | 9,880 | 34,500 | 66,900 | 68,900 | 54,700 | 14,300 |
| Ca | 4 | 11 | 169 | 608 | 260 | 74 | 6.000 |
| Mg | | 7.2 | 108 | 118 | 35 | 9.0 | <6 |
| K | 2490 | 8.7 | 17 | 30 | 31 | 30 | 14 |
| S | 50,900 | 6,500 | 23,300 | 44,200 | 48,400 | 48,600 | 16,400 |
| B | 3,730 | 56 | 636 | 2,600 | 3,280 | 3,450 | 4,410 |
| Li | 15,040 | 0 | 0 | 127 | 2,120 | 7,260 | 5,760 |

TABLE 2
Eluate Composition

| LIMS. | | | | | | | | |
|---|---|---|---|---|---|---|---|---|
| 181212 | -01 | -02 | -03 | -04 | -05 | -06 | -07 | -08 |
| Eluate | 960 ml | 1070 ml | 1400 ml | 1820 ml | 2180 | 2700 | 3120 | 3330 |
| | 28-Dec | 28-Dec | 28-Dec | 28-Dec | 28-Dec | 28-Dec | 28-Dec | 28-Dec |
| Na | 320 | 2,300 | 5,640 | 6,880 | 6,790 | 6,600 | 6,080 | 500 |
| Ca | <10 | <5 | <5 | <10 | <5 | <5 | <10 | <5 |
| Mg | <10 | <5 | <5 | <10 | <5 | <5 | <10 | <5 |
| K | 14 | 67 | 170 | 210 | 210 | 210 | 200 | 18 |
| S | 68 ² | 28 ² | <20 | <25 | <20 | <20 | 18 ² | <20 |
| p-Alk | 665 | 5,740 | 11,000 | 13,900 | 13,600 | 12,000 | 12,800 | 673 |
| t-Alk | 1,730 | 14,600 | 36,500 | 44,700 | 45,700 | 45,600 | 41,800 | 3,190 |
| TIC | 351 | 2,670 | 6,140 | 7,650 | 7,960 | 8,220 | 7,330 | 619 |
| B | <15 | <10 | <10 | <15 | <10 | <10 | <10 | <10 |
| LI | 164 | 1,230 | 3,180 | 3,850 | 4,020 | 3,950 | 3,750 | 310 |

### Experimental Test 2

A test demonstrating the conversion of aqueous LiCl in to aqueous LiOH using the metathesis system of the present invention was conducted. The test converted 1 Kg LiCl (dry basis) to a 3% solution of LiOH. Yield loss of Li was approximately 7%. In this test, resin was obtained from a water softener supply reseller. The resin was of gel type with particle size distribution estimated to be between 300 to 1200 microns in diameter. Crosslinking was estimated to be 8 w/w % divinylbenzene. The ion exchange capacity of resin was estimated to be 2.2 meq/l. The resin was installed in 3 clear PVC columns with internal diameter of 1.375″ and a length of 42″. The columns were completely filled with no provision for bed expansion. Each column held approximately 800 ml of resin, for a total of 2400 ml. In view of the estimated ion exchange capacity of 2.2 meq/l, the total column ion exchange capacity was approximated to 5.3 meq. The reagent usage for the test is shown in Table 3 below.

TABLE 3
Reagent Usage

| Reagent | LiCl | NaOH |
|---|---|---|
| Total solution kg | 20.34 | 17.82 |
| Unused Solution kg | 0 | 0.92 |
| Total Reagent | 1.01 | 1.07 |
| (kg - dry basis) | | |
| Concentration mol/kg | 1.17 | 1.50 |

The resin was conditioned with a double regenerant of HCl and rinsed to a conductivity of 25 ppm. The resin used was in H⁺ form for the initial cycle. The initial cycle, shown as cycle 0 in Table 4 below, loaded 3840 g of LiCl solution (4.5 moles) onto the column, followed by a rinse. First elution of LiOH solution was conducted with 3.0 moles of NaOH. A total of 7 cycles were conducted and a composite of each eluate and raffinate was sampled. Flowrates of reagents and rinses were measured and found to vary from 32 g/min to 45 g/min. A conductivity meter was located at the discharge of the final column for measurements. Each charge of LiCl or NaOH was followed by a charge of rinse water with conductivity less than 125 ppm, adequate to bring the conductivity of the discharge below 250 ppm. The following actions were conducted based on the measured conductivity:
a) between 125 and 250 ppm the discharge was collected as recycle rinse water;
b) between 250 and 4000 ppm, the discharge was collected as inter-rinse discard and consolidated; and,
c) above 4000 ppm, the discharge was collected in either the LiOH Eluate Composite or NaCl Raffinate Composite.

TABLE 4
Operational Data

| Cycle | 0 | 1 | 2 | 3 | 4 | 5 | 6 | 7 |
|---|---|---|---|---|---|---|---|---|
| Date | 10-29 | 11-02 | 11-03 | 11-04 | 11-04 | 11-05 | 11-05 | 11-06 |
| Moles OH | | 3.0 | 3.5 | 3.5 | 3.5 | 3.7 | 3.5 | 3.6 |
| Mass NaOH sol g | | 2000 | 2332 | 2332 | 2332 | 2445 | 2332 | 2434 |
| Breakthrough g | | 1844 | 1324 | 1360 | 1170 | 1170 | 1165 | 1190 |
| Duration min | | 62 | 51 | 54 | 52 | 54 | 57 | 105 |
| Breakthru min | | 57 | 29 | 31 | 27 | 26 | 24 | 59 |
| Rinse g | | 1998 | 1817 | 2433 | 2345 | 3337 | 1960 | 2427 |
| Res Time Rinse | | 42 | 42 | 57 | 56 | 68 | 47 | 165 |
| Sample Name | — | LiOH 1 | LiOH 2 | LiOH 3 | LiOH 4 | LiOH 5 | LiOH 6 | See |
| | | | | | | | | Table 5 |
| | | | | | | | | below |
| Date | 11-02 | 11-02 | 11-03 | 11-04 | 11-05 | 11-05 | 11-06 | |
| Moles Li | 4.5 | 3.0 | 3.0 | 3.1 | 3.1 | 3.1 | 3.6 | |
| Mass LiCl sol g | 3840 | 2560 | 2560 | 2650 | 2650 | 2650 | 3089 | |
| Breakthrough | 1137 | 1139 | 1123 | 1119 | 1180 | 1180 | 1180 | |
| Duration min | 185 | 59 | 58 | 61 | 60 | 63 | 71 | |
| Res Time min | 55 | 27 | 27 | 27 | 27 | 27 | 27 | |
| rinse g | 2294 | 1658 | 2115 | 1983 | 2342 | 2165 | 2090 | |
| Rinse duration | 70 | 39 | 51 | 46 | 53 | 51 | 96 | |
| min | | | | | | | | |
| Sample Name | Rinse 1 | NaCl 1 | NaCl 2 | NaCl 3 | NaCl 4 | NaCl 5 | NaCl 6 | |

TABLE 5
Elution Curve, LiOH 7

| Sample Name | 7a | 7b | 7c | 7d | 7e | 7f |
|---|---|---|---|---|---|---|
| Grams after | 511 | 532 | 520 | 520 | 520 | 520 |
| Breakthrough | | | | | | |
| Li ppm | 5,600 | 9,400 | 9,750 | 9,470 | 680 | 229 |
| Na ppm | 900 | 600 | <500 | 700 | 10,000 | 8,200 |

The experimental yield is shown in Table 6 below and indicates that 11.7 g of lithium were lost in the NaCl raffinate which represents a yield loss of 7.4% of lithium. This excess of lithium in the raffinate is due primarily to diffusion limitations for the time frame of each cycle. The total loading/unloading cycle was approximately 2 hours, not including rinses. As such, the experiment may result in lower lost yield of lithium by using slower cycle times. The experiment may be further ameliorated with larger stoichiometric excess of resin over the Li charge for each cycle or by using smaller or more uniform resin beads. Lower crosslinking of beads is another option that will improve kinetics but may reduce volumetric capacity of the resin bed. Natural kinetics may be improved by increasing the temperature of the operation to 65 degree C., which may increase diffusion 16 fold (doubling of diffusion is expected with every 10 degree C. increase in temperature). A commercial unit operating at a higher temperature within the operating range of resin, for example at 65 degrees C., may reduce capital cost and increase yield.

TABLE 6
Overall Balance

| | | | | | | Inter | On |
|---|---|---|---|---|---|---|---|
| | LiCl | NaOH | | LiOH | NaCl | Rinse | Resin |
| Sample | Feed | Feed | Rinse 1 | Eluate | Raffinate | Discard | after 7 |
| Mass g | 20,340 | 16,900 | 5,021 | 17,723 | 18,055 | 8,776 | |
| Li ppm | 7,780 | | | | 649 | 261 | |
| Na ppm | | 34,400 | | 5600 | 20,900 | 300 | |
| Cl ppm | 41,700 | | | | 37,000 | 200 | |
| Li g | 158.2 | | | | 11.7 | 2.3 | 3 |
| Na g | | 581 | | 112 | 377 | 2.6 | 92 |
| Cl g | 848 | | 160 | | 688 | 1.7 | |

### Experimental Test 3

In this experiment, the resin was eluted in a two-step fashion, for example as shown in FIG. 9, with the primary eluent representing the diluted recycle from the LiOH*H₂O crystallizer. A lithium bearing solution (feed) was prepared with technical grade chemicals as shown in Table 7 below. A single packed column of strong cation exchange resin, gel type, with 8% crosslinking and a bead size of 100 to 200 US mesh measuring 1.8 cm in diameter and 495 mm in length having total exchange capacity of 0.24 g-moles, was used. The resin bed was operated in a reciprocating fashion with feed entering from a first end and eluents, both primary and secondary entering from a second end. Eluate was collected from the second end and raffinate was collected from the first end.

A cycle according to Experiment 3 consisted of loading Li on the resin by adding 116 g of feed to a first end, and eluting 136.6 g of raffinate from a second end. The flow was then reversed by adding recycled rinse water followed by 23 g of fresh rinse to the second end. Li was then eluted on resin by adding 22 g of primary eluent to the second end. Following the primary eluent, 98g of secondary eluent was added and 142.8 g of eluate was collected from the first end of the resin. Flow was reversed again by adding recycled rinse water followed by 23 g of fresh rinse to the first end of the resin and the cycle was repeated.

The experiment was operated at approximately 20 C. Each complete cycle had a duration of 62 minutes. In this experiment the above cycle was repeated 12 times to allow the resin and the recycled rinse waters to come to equilibrium. On the 12^{th} cycle, samples of eluate and raffinate were analyzed and the results are shown in Table 7, below.

TABLE 7

| | | Secondary | Primary | | |
|---|---|---|---|---|---|
| Constituent | Feed | Eluent | Eluent | Raffinate | Eluate |
| Weight g | 116 | 98 | 22 | 136.6 | 142.8 |
| Li ppm | 6920 | | 3204 | 16 | 6260 |
| K ppm | 446 | | 2252 | 425 | 240 |
| Na ppm | 2546 | 26700 | 16800 | 20200 | 2130 |
| B ppm | 690 | | | 550 | 0.6 |
| Cl ppm | 37411.5 | | | 29796 | 29 |
| OH ppm | 0 | 19735 | 21290.43 | | 17088 |
| Total ppm | 48014 | 46435 | 43546 | 50987 | 25748 |

Based on the above results, lithium loss to raffinate was 0.3% of feed. Stoichiometric requirement for secondary eluent was 101% of lithium value in feed. Chloride and boron contamination of eluate was less than 0.1% of feed value.

1. A method of treating a lithium solution comprising,
passing a feed stream comprising lithium ions through a cation exchange resin loaded with monovalent cations other than lithium;
exchanging the lithium ions of the feed stream with the monovalent cations of the ion exchange resin so as to convert the ion exchange resin from the counterion form to a lithium ion form;
expelling a raffinate stream comprising the monovalent cations;
passing an eluent stream comprising monovalent cations of hydroxide or bicarbonate through the ion exchange resin having the lithium ion form;
exchanging the monovalent cations of the eluent stream with the lithium ions of the ion exchange resin;
eluting an eluate stream comprising lithium ions.

2. The method of claim 1 wherein the ion exchange resin is a strong acid cation exchange resin.

3. The method of claim 1 wherein the ion exchange resin is arranged as a column or two or more columns arranged in series.

4. The method of claim 3 wherein the ion exchange resin is employed in a series of columns, arranged in a ring, with eluent, feed, and rinses injected and eluate and raffinate withdrawn in a simulated moving bed (SMB).

5. The method of claim 3 wherein the feed and eluent are alternately passed through the column from opposing ends with raffinate and eluent also removed from opposing ends, optionally with a rinse buffer passed back and forth through the column prior to introducing feed or eluent, as in the manner commonly referred to as reciprocating bed ion exchange.

6. The method of claim 1 further comprising adding a low conductivity rinse to the resin after the addition of the feed or the eluent.

7. The method of claim 1 wherein the counterions are sodium ions (Na+), hydrogen ions (H+) or potassium ions (K+).

8. The method of claim 1 wherein the eluent stream comprises sodium hydroxide (NaOH), sodium bicarbonate (NaHCO₃), sodium carbonate or a mix of NaHCO₃ and sodium carbonate (Na₂CO₃).

9. The method of claim 1 wherein the raffinate stream further comprises non-ionic components of the feed.

10. The method of claim 1 further comprising a step of evaporative crystallizing the eluate stream to form a lithium rich cake and a concentrated mother liquor, high in Na/K compared to the eluate.

11. The method of claim 10 comprising a step of using the concentrated mother liquor, after dilution, as a primary eluent.

12. The method of claim 10 comprising producing CO₂ from the evaporation eluate stream and at least one of i) reusing the CO₂ to convert the mother liquor from the carbonate form to the bicarbonate form to use as a primary eluent, and ii) reusing the CO₂ to convert fresh Na₂CO₃ to NaHCO₃ to use as a secondary eluent.

13. A system for lithium metathesis, the system comprising,
an ion exchange resin having,
a loading configuration with a feed input and a raffinate output;
an elution configuration with an eluent input and an eluate output;
a monovalent other than lithium form in the loading configuration; and,
a lithium ion form in the elution configuration;
a feed stream comprising lithium ions and anions added to the resin through the feed input;
a raffinate stream comprising monovalent cations other than Li from the ion exchange resin and the anions from the feed stream, expelled from the resin through the raffinate output;
an eluent stream comprising monovalent cations (other than Li) and anions, added to the resin through the eluent input; and,
an eluate stream comprising the lithium ions of the resin and the anions of the eluent stream, eluted from the resin through the eluate output.

14. The system of claim 13 wherein when the feed stream is added to the ion exchange resin in the loading configuration, the raffinate stream is expelled and the ion exchange resin is converted to the elution configuration.

15. The system of claim 13 wherein when the eluent stream is added to the ion exchange resin in the elution configuration, the eluate stream is eluted and the ion exchange resin is converted to the loading configuration.

16. The system of claim 13 wherein the ion exchange resin is arranged in a column.

17. The system of claim 16 wherein two or more columns are arranged in series.

18. The system of claim 17 wherein the columns arranged in series are arranged in a continuous loop in a simulated moving bed process (SMB).

19. The system of claim 13 wherein the ion exchange resin is a strong acid cation exchange resin.

20. The system of claim 13 wherein the ion exchange resin in the loading configuration is in a Na+ or K+ form.

21. The system of claim 13 wherein the eluent stream comprises sodium hydroxide (NaOH), sodium bicarbonate (NaHCO₃) or a mix of NaHCO₃ and sodium carbonate (Na₂CO₃).

22. The system of any one of claim 13 further comprising a crystallization stage, optionally including a precipitation stage using direct steam or boiling by indirect heat.

23. (canceled)
